(19) United States
(12) Patent Application Publication
(10) Pub. No.: US 2025/0371407 A1
(43) Pub. Date: Dec. 4, 2025

(54) MACHINE-LEARNED MODELS FOR COLOCATING DISTRIBUTED WORKLOADS VIA METRIC LEARNING

(71) Applicant: Red Hat, Inc., Raleigh, NC (US)

(72) Inventor: Yuan Tang, Indianapolis, IN (US)

(21) Appl. No.: 18/677,256

(22) Filed: May 29, 2024

(51) Int. Cl. G06N 20/00

(52) U.S. Cl. CPC G06N 20/00

(57) ABSTRACT

Historical performance metrics are obtained for a first compute node located in a first physical geographic location and a first storage node located in a second physical geographic location different than the first physical geographic location. The historical performance metrics are processed with a machine-learned node pairing optimization model to obtain a training output indicative of a predicted data transfer performance for a compute-storage pairing comprising the first compute node and the first storage node. A training process is performed to train the machine-learned node pairing optimization model based at least in part on the training output indicative of the predicted data transfer performance for the compute-storage pairing.

### BACKGROUND

In recent years, distributed computing has emerged as the primary architecture for processing and managing large-scale data across multiple interconnected systems. Unlike traditional centralized computing systems, distributed computing involves a network of “nodes,” such as compute nodes that perform computing operations, or storage nodes that store information. For example, a compute node may receive a request to process a set of information. In a centralized computing system, the compute node can generally retrieve the set of information from its own memory. However, in a distributed computing system, the compute node may instead request the set of information from a storage node.

This approach enhances computational power, scalability, and fault tolerance by distributing tasks across multiple nodes. Although each node can operate independently, nodes often work in concert to perform complex computations, data storage (e.g., content distribution networks, cloud-based data backups, etc.), and/or resource management. Distributed computing systems often includes components such as distributed databases, parallel processing frameworks, and cloud-based platforms, which collectively enable efficient data processing and resource utilization.

### SUMMARY

Implementations described herein enable co-location of distributed workloads via metric learning. More specifically, a computing system can obtain historical performance information for compute nodes and storage nodes within a distributed computing environment. The computing system can process the historical performance information with a machine-learned node pairing optimization model trained via metric learning to pair compute nodes and storage nodes. By selecting the pairings based on performance information, implementations described herein can identify pairings that provide optimal performance.

In one implementation, a method is provided. The method includes obtaining, by a computing system comprising one or more computing devices, historical performance metrics for a first compute node located in a first physical geographic location and a first storage node located in a second physical geographic location different than the first physical geographic location. The method further includes processing, by the computing system, the historical performance metrics with a machine-learned node pairing optimization model to obtain a training output indicative of a predicted data transfer performance for a compute-storage pairing comprising the first compute node and the first storage node. The method further includes performing, by the computing system, a training process to train the machine-learned node pairing optimization model based at least in part on the training output indicative of the predicted data transfer performance for the compute-storage pairing.

In another implementation, a computing system is provided. The computing device includes a memory, and one or more processor device coupled to the memory. The processor device(s) are to obtain historical performance metrics for a compute node located in a first physical geographic location. The processor device(s) are further to process the historical performance metrics with a machine-learned node pairing optimization model to obtain an embedding for the compute node. The processor device(s) are further to determine, within an embedding space, a plurality of pairwise distances between the embedding for the compute node and a plurality of embeddings for a respective plurality of storage nodes located at a plurality of second physical geographic locations each different than the first physical geographic location. The processor device(s) are further to, based on the plurality of pairwise distances, assign the compute node to a first storage node of the plurality of storage nodes, wherein a physical distance between the compute node and the first storage node is greater than a physical distance between the compute node and a second storage node of the plurality of storage nodes.

In another implementation, a non-transitory computer-readable storage medium is provided. The non-transitory computer-readable storage medium includes executable instructions to cause processor device(s) to obtain historical performance metrics for a first compute node located in a first physical geographic location and a first storage node located in a second physical geographic location different than the first physical geographic location. The instructions further cause the processor device(s) to process the historical performance metrics with a machine-learned node pairing optimization model to obtain a model output indicative of a predicted data transfer performance for a compute-storage pairing comprising the first compute node and the first storage node. The instructions further cause the processor device(s) to perform a training process to train the machine-learned node pairing optimization model based at least in part on the model output indicative of the predicted data transfer performance for the compute-storage pairing.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1A is a block diagram of a distributed computing environment suitable for training a machine-learned model for distributed workload colocation via metric learning according to some implementations of the present disclosure.

FIG. 1B is a block diagram of a distributed computing environment suitable for leveraging a trained machine-learned node pairing optimization model for inference to identify optimal compute-storage pairings according to some implementations of the present disclosure.

FIG. 2 is a flowchart of a method for coverage based risk mitigation for containers according to some implementations of the present disclosure.

FIG. 3 is a simplified block diagram of the environment illustrated in FIG. 1A according to one implementation of the present disclosure.

FIG. 4 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

In recent years, distributed computing has emerged as the primary architecture for processing and managing large-scale data across multiple interconnected systems. This approach enhances computational power, scalability, and fault tolerance by distributing tasks across multiple nodes. Although each node can operate independently, nodes often work in concert to perform complex computations, data storage (e.g., content distribution networks, cloud-based data backups, etc.), and/or resource management. Distributed computing systems often includes components such as distributed databases, parallel processing frameworks, and cloud-based platforms, which collectively enable efficient data processing and resource utilization.

Unlike traditional centralized computing systems, distributed computing involves a network of “nodes,” such as compute nodes that perform computing operations, or storage nodes that store information. For example, a compute node may receive a request to process a dataset. In a centralized computing system, the compute node can generally retrieve the dataset from its own memory. However, in a distributed computing system, it's likely that the dataset is instead stored to a storage node. The storage node can transfer the dataset to the compute node so that the compute node can process the dataset.

Distributed systems often involve data processing and network communication across different clusters of machines that are located in different physical locations. However, despite the benefits provided by distributed computing architectures, the process to transfer datasets from storage nodes to compute nodes can requires substantial computing resources (e.g., memory, storage, network bandwidth, compute cycles, power, etc.). These resource costs can be exacerbated when datasets are spread across multiple storage nodes that each must communicate with a compute node.

As such, data transfer performance is a major consideration when pairing compute nodes and storage nodes. Compute nodes are typically paired to storage nodes believed to provide the greatest data transfer performance (e.g., minimal latency, high bandwidth, etc.). Conventionally, compute nodes have been paired with storage nodes based on a distance between the physical geographic location of each node. This assumes that physical distance is a sufficiently accurate indicator of data transfer performance. For example, assume that a compute node is located in the Seattle. Further assume that one storage node is located in Denver while another storage node is located in Chicago. In this instance, the compute node located in Seattle would likely be paired to the storage node located in Denver due to Denver storage node being closer to the compute node than the Chicago storage node.

However, in many instances, compute-storage pairings determined based on physical distance are sub-optimal. This is because many other performance factors (e.g., network infrastructure between nodes, software installed to nodes, available computing resources, etc.) exert a greater effect on the performance of compute-storage pairings than a physical geographic distance. To follow the previous example, assume that data transfers between the Seattle compute node and the Chicago storage node can utilize a direct line of high-speed network infrastructure. Further assume that data transfers between the Seattle compute node and the Denver storage node must instead utilize an indirect “zig-zagging” line of lower-speed network infrastructure. Given this scenario, even though the physical distance from the Seattle compute node to the Chicago storage node is greater than the distance to the Denver storage node, the Chicago storage node can still provide greater data transfer performance due to the availability of high-speed network infrastructure. As such, a technique to identify compute-storage pairings based on performance metrics is greatly desired.

Accordingly, implementations described herein propose machine-learned models for colocating distributed workloads via metric learning. More specifically, a computing system (e.g., a network node, etc.) can obtain historical performance information (e.g., historic data transfer speeds, bandwidth availability, processor utilization, storage resource availability, storage capacity, processing capacity, etc.) for a first compute node located in a first physical geographic location. The historical performance information can also be obtained for a first storage node located in a second physical geographic location.

The computing system can process the historical performance information with a machine-learned model (by way of non-limiting example, a metric learning function or learned distance function such as a Mahalanobis distance function, or any other suitable model) to obtain a performance output. Such machine-learned model may be referred to herein as a machine-learned node pairing optimization model. The performance output can indicate a predicted data transfer performance for a compute-storage pairing that includes the first compute node and the first storage node. For example, the performance output may include predicted data transfer performance metrics for data transfers between the first compute node and the first storage node. For another example, the performance output may be a binary label indicating whether predicted data performance for the compute-storage pair is sufficient.

In some implementations, to determine the predicted data transfer performance, the historical performance information can be processed with an embedding portion of the machine-learned node pairing optimization model to generate a first embedding for the compute node (i.e., a compute node embedding) and a second embedding for the storage node (i.e., a storage node embedding). The embeddings can be mapped to a learned embedding space. The computing system can generate the performance output based on the distance between the first embedding and the second embedding within the learned embedding space.

Based on the performance output, the computing system can perform a training process (e.g., a supervised training process, a weakly supervised training process, an unsupervised training process, etc.) to train the machine-learned node pairing optimization model. For example, the computing system can train the model with a loss function that evaluates a difference between the performance output and a known “ground-truth” label indicating a known data transfer performance for the compute-storage pairing. In this manner, the computing system can train the machine-learned node pairing optimization model to identify more optimal compute-storage pairings.

Once trained, the machine-learned node pairing optimization model can be used for inference. For example, the computing system can use the trained machine-learned node pairing optimization model to generate embeddings for a set of compute nodes and a set of storage nodes. The computing system can determine pairwise distances between each pair of nodes, and can select one or more compute-storage pairings with the lowest pairwise distances. In such fashion, implementations described herein can train and utilize a machine-learned node pairing optimization model to generate compute-storage pairings more effectively than conventional approaches.

Implementations described herein provide a number of technical effects and benefits. As one example technical effect and benefit, implementations described herein can substantially improve data transfer performance for data transfers between storage nodes and compute nodes. More specifically, conventional approaches to determine compute-storage pairings do so based on physical distance. As described previously, determining such pairings based on physical distance can lead to sub-optimal pairings that utilize greater quantities of computing resources than necessary (e.g., compute cycles, bandwidth, memory, storage, etc.). However, implementations described herein enable the determination of more efficient compute-storage pairings via metric learning, thus substantially reducing, or eliminating, the expenditure of computing resources caused by inefficient compute-storage pairings.

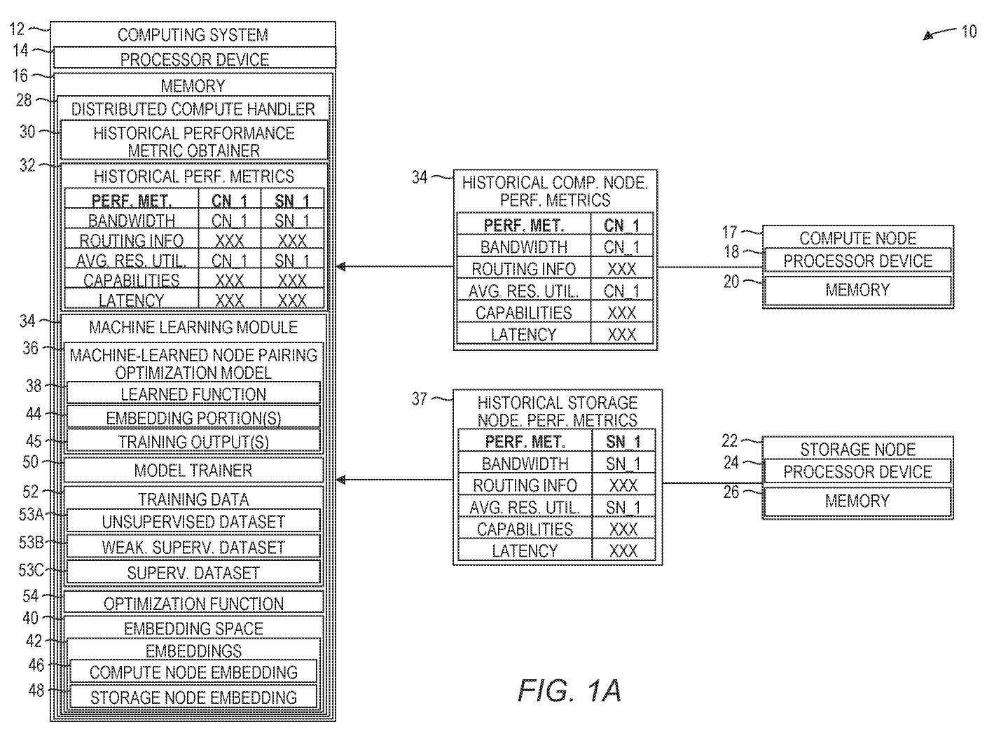

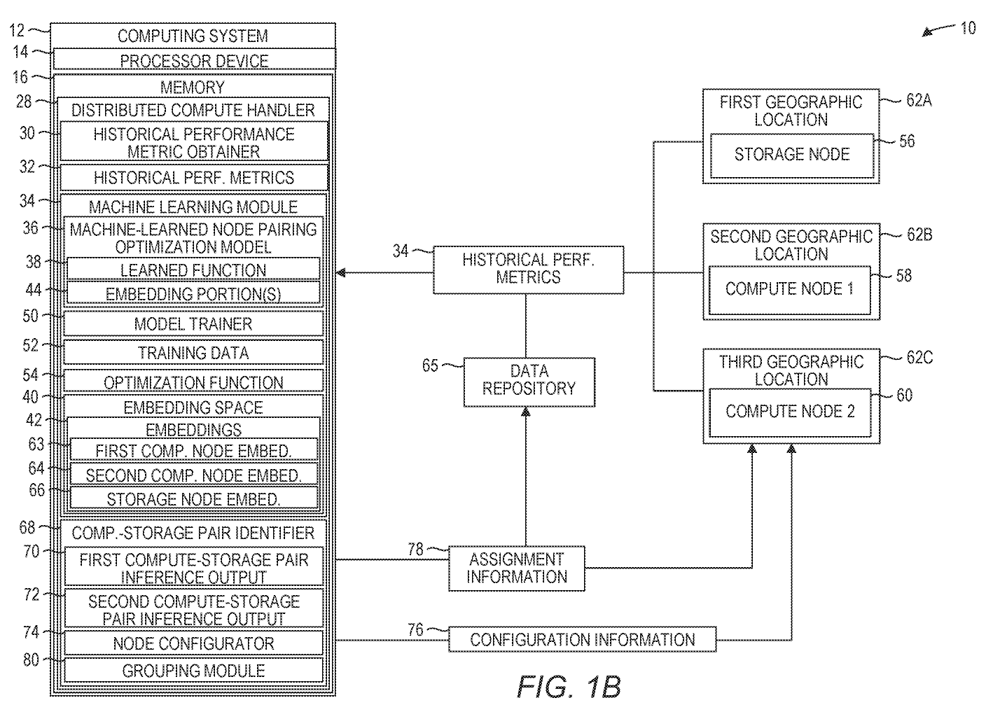

FIG. 1A is a block diagram of a distributed computing environment 10 suitable for training a machine-learned model for distributed workload colocation via metric learning according to some implementations of the present disclosure. The distributed computing environment 10 can include a computing system 12 with one or more processor device(s) 14 and a memory 16. In some implementations, the computing system 12 may be a computing system that includes multiple computing devices. Alternatively, in some implementations, the computing system 12 may be one or more computing devices within a computing system that includes multiple computing devices. Similarly, the processor device(s) 14 may include any computing or electronic device capable of executing software instructions to implement the functionality described herein.

The memory 16 can be or otherwise include any device(s) capable of storing data, including, but not limited to, volatile memory (random access memory, etc.), non-volatile memory, storage device(s) (e.g., hard drive(s), solid state drive(s), etc.). In some implementations, the memory 16 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

The distributed computing environment 10 can include multiple types of nodes. As described herein, a “node” generally refers to a discrete unit of hardware and/or software resources. In some instances, nodes within the distributed computing environment 10 can be configured to perform specific tasks. For example, some nodes within the distributed computing environment 10 can be configured as “compute” or “processing” nodes that handle processing tasks or provide processing-heavy services. Compute nodes are generally allocated with hardware devices that can facilitate processing tasks, such as Graphics Processing Units (GPUs), Central Processing Units (CPUs), Application-specific Integrated Circuits (ASICs), Field-Programmable Gate Arrays (FPGAs), etc.

Conversely, storage nodes are generally allocated with hardware devices to facilitate storage tasks, such as storage devices (e.g., hard drives, etc.), memory, high-bandwidth network devices, physical storage media, etc.). It should be noted that in some instances, storage nodes can include processing devices (e.g., CPUs, etc.) to facilitate storage operations (e.g., read/write operations) and processing nodes can include storage devices (e.g., random access memory) to facilitate processing operations.

In many instances, compute nodes and storage nodes work in concert to perform processing operations. More specifically, data that is to be processed at a compute node is often located at a storage node. The storage node can provide the data to the compute node in response to a request, and the compute node can process the data received from the storage node in accordance with some task. If the task performed by the compute node produces a task output, the compute node can return the task output to the requesting entity, and/or store the task output to the storage node that provided the data (or another storage node).

In particular, the distributed computing environment 10 can include a compute node 17 with processor device(s) 18 and a memory 20 as described with regards to the processor device(s) 14 and the memory 16 of the computing system 12. Specifically, in some implementations, the processor device(s) 18 of the compute node 17 can include physical processor device(s) (e.g., GPUs, CPUs, etc.). Additionally, or alternatively, in some implementations, the processor device(s) 18 can include virtualized device(s), or abstract representations of physical device(s)

The distributed computing environment 10 can include a storage node 22 with storage device(s) 24 and a memory 26 as described with regards to the memory 16 of the computing system 12. The storage device(s) can include any type of physical storage device(s) (e.g., physical storage media, hard drives, etc.) and/or virtualized storage devices or abstract representation(s) of storage devices. The storage node 22 may perform storage operations via a storage service implemented by the storage node 22.

Returning to the computing system 12, the memory 16 of the computing system 12 can include a distributed compute handler 28. The distributed compute handler 28 can implement, orchestrate, manage, etc. distribution of computing tasks. For example, the computing system 12 may obtain workload information that specifies a data processing task. The distributed compute handler 28 can then identify a compute node with sufficient resources to perform the task. More specifically, different compute nodes can be allocated with different types of computing resources, and compute nodes can be selected based on the type of compute resource required to perform a task. For example, if the task is a machine-learned model training task, the distributed compute handler 28 can identify a compute node that includes a GPU or an analogous device sufficient to perform model training tasks.

In some implementations, the distributed compute handler 28 can also identify a storage node that includes the data to be processed for the data processing task. In some implementations, if multiple storage nodes include the data, the distributed compute handler 28 can select the storage node based on performance characteristics (e.g., bandwidth, throughput, latency, current utilization, costs, etc.). For example, if two storage nodes include the data to be processed, the distributed compute handler 28 may select the storage node that with the lowest degree of current or predicted utilization. For another example, assume that two storage nodes are both implemented by two different cloud service providers. Further assume that both cloud service providers assign different costs to data retrieval operations. The distributed compute handler 28 may select the storage node associated with the cloud service provider with the lowest cost associated with data retrieval operations.

The nodes within the distributed compute environment 10 are often distributed across multiple different physical geographic locations. For example, one compute node may be located in the Northeast United States while another compute node is located in the Southwest United States and a storage node is located in the Midwest United States. Due to the varying distances between nodes, performance between nodes can also vary. However, as described previously, distance is not always sufficient when selecting optimal pairs of nodes (e.g., a paired compute node and storage node). As such, the distributed compute handler 28 can obtain historical performance metrics to identify optimal node pairings.

The distributed compute handler 28 can include a historical performance metric obtainer 30. The historical performance metric obtainer 30 can obtain historical performance metrics 32 from nodes within the distributed computing environment 10, such as the compute node 17 and the storage node 22. In some implementations, the historical performance metric obtainer 30 can obtain the historical performance metrics 32 from the compute node 17 and the storage node 22 based on a request for historic performance metrics sent to the nodes. Additionally, or alternatively, in some implementations, the historical performance metric obtainer 30 can obtain the historical performance metrics 32 from another entity (e.g., a performance monitoring entity, etc.) that monitors performance of the nodes. Additionally, or alternatively, in some implementations, the historical performance metric obtainer 30 can obtain the historical performance metrics 32 by monitoring performance at the nodes 17 and 22 while operations are performed.

The historical performance metric obtainer 30 can obtain historical compute node performance metrics 34 from the compute node 17. The historical compute node performance metrics 34 can describe a performance of the compute node 17 when performing prior processing operations. For example, the historical compute node performance metrics 34 may include average performance metrics that describe an average performance based on the last five operations or tasks completed by the compute node 17.

The historical compute node performance metrics 34 can include any type or manner of performance metrics for the compute node, such as operation completion time, historic processor utilization, memory utilization, bandwidth (e.g., data exchange bandwidth, data processing bandwidth, etc.), current processor utilization, latency, etc. In addition, the historical compute node performance metrics 34 can include minimums, maximums, averages, etc. for the metrics. The historical compute node performance metrics 34 can also describe various capabilities of the compute node, such as types and/or quantities of available computing resources, available encryption or decryption schemes, processing software (e.g., rendering engines, operating systems, etc.) security capabilities (e.g., data retention policies, access permissions, firewall capabilities, etc.), etc.

The historical performance metric obtainer 30 can obtain historical storage node performance metrics 35 from the storage node 22. The historical storage node performance metrics 35 can describe a performance of the storage node 22 when performing prior storage operations. For example, the historical storage node performance metrics 35 may include average performance metrics that describe an average performance based on the last five operations or tasks completed by the storage node 22.

The historical storage node performance metrics 35 can include any type or manner of performance metrics for the storage node, such as operation completion time, historic device utilization, memory utilization, bandwidth (e.g., data transfer bandwidth, read/write bandwidth, etc.), current storage device utilization, latency, etc. In addition, the historical storage node performance metrics 35 can include minimums, maximums, averages, etc. for the metrics. The historical storage node performance metrics 35 can also describe various capabilities of the storage node, such as types and/or quantities of available computing resources, available encryption or decryption schemes, processing software (e.g., storage indexing and/or search applications, operating systems, etc.) security capabilities (e.g., data retention policies, access permissions, firewall capabilities, etc.), etc.

The historical performance metrics 32 can include the historical compute node performance metrics 34 and the historical storage node performance metrics 35. In some implementations, the historical performance metrics 32 can include performance metrics for interactions between specific pairings of compute nodes and storage nodes. For example, the historical performance metrics 32 can include performance metrics for data transfer operations between the storage node 22 and the compute node 17 (e.g., data transfer bandwidth, latency, etc.). In some implementations, the historical performance metrics 32 can describe historic data routing information for data transmitted between the storage node 22 and the compute node 17. The historic data routing information can indicate the path taken by data transmitted from the storage node 22 to the compute node 17 (e.g., intermediate nodes or routers, etc.).

The distributed compute handler 28 can include a machine learning module 33. The machine learning module 33 can handle instantiation, training, utilization (e.g., for inference), and/or implementation of various machine-learned model(s), such as a machine-learned node pairing optimization model 36. The machine-learned node pairing optimization model 36 can be, or otherwise include, any type or manner of model or learned function. Examples can include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

Additionally, or alternatively, in some implementations, the machine-learned node pairing optimization model 36 can be, or otherwise include, a learned function 38. As described herein, a “learned function” refers to a function with weights or parameters that can be adjusted over time based on training examples. For example, the learned function 38 can be a learned distance function, such as a Mahalanobis distance function, that evaluates the distance between two embeddings within an embedding space.

In particular, the machine-learned node pairing optimization model 36 can be trained to generate an output (e.g., training output(s) 45, inference-stage outputs, etc.) indicative of a predicted data transfer performance for a compute-storage pairing that includes a compute node and a storage node. For example, the output of the machine-learned node pairing optimization model 36 may be, or include, an evaluated distance between representations of the compute nodes and storage nodes within a lower-dimensional space. For another example, the machine-learned node pairing optimization model 36 may perform intermediate operations (e.g., distance evaluation) to generate a final output that describes a particular compute-storage pairing of a number of candidate compute-storage pairings. In some implementations, the outputs of the machine-learned node pairing optimization model 36 can include predicted performance metrics for future data transfers between the paired nodes. Additionally, or alternatively, in some implementations, the outputs of the machine-learned node pairing optimization model 36 can include information indicating whether the compute-storage pairing is a “positive” or sufficient pairing.

More specifically, the machine-learned node pairing optimization model 36, or the machine learning module 33, can include an embedding space 40. The embedding space 40 can include a plurality of embeddings 42. The embeddings 42 can be generated based on the historical performance metrics 32. The distance between embeddings within the embedding space 40 can be indicative of a predicted degree of performance between a pairing of the nodes that are associated with the embedding. It should be noted that the “distance” between the embeddings 42 within the embedding space 40 does not necessarily refer to a physical distance. Rather, the distance refers to a learned distance that can be evaluated using the machine-learned node pairing optimization model 36.

For example, if a first storage node embedding is “closer” to a compute node embedding than a second storage node embedding, the predicted degree of performance between a pairing of the first storage node and the compute node will be greater than the predicted degree of performance between a pairing of the second storage node and the compute node.

In some implementations, the embedding space can be populated with a set of embeddings for compute nodes and/or storage nodes. For example, the distributed compute handler 28 can obtain historical performance training data for a set of compute nodes and a set of storage nodes. The distributed compute handler 28 can process historical performance training data with the machine-learned node pairing optimization model 36 to obtain a plurality of performance outputs indicative of predicted data transfer performance for a plurality of compute-storage pairings, each comprising a compute node of the set of compute nodes and a storage node of the set of storage nodes. The distributed compute handler 28 can perform a training process to train the machine-learned node pairing optimization model 36 based at least in part on the plurality of performance outputs.

In some implementations, the machine-learned node pairing optimization model 36 can include an embedding portion 44 (e.g., one or more encoding layers, etc.) that can process some (or all) of the historical performance metrics 32. For example, the embedding portion(s) 44 can process the historical compute node performance metrics 34 to generate a compute node embedding 46. The compute node embedding 46 can serve as a lower-dimensional representation of the historical compute node performance metrics 34. Similarly, the embedding portion(s) 44 can process the historical storage node performance metrics 37 to generate a storage node embedding 48. The storage node embedding 48 can serve as a lower-dimensional representation of the historical storage node performance metrics 37.

The machine learning module 33 can include a model trainer 50. The model trainer 50 can train the machine-learned node pairing optimization model 36 using training data 52 and an optimization function 54. The model trainer 50 can utilize any type or manner of training scheme or technique, such as unsupervised training, weakly or semi supervised training, fully supervised training, etc. For example, the training data 52 can include an unsupervised dataset 53A, a weakly supervised dataset 53B, and/or a supervised dataset 53C (generally, datasets 53). The datasets 53 can be utilized to perform different types of training processes (e.g., unsupervised training, weakly supervised training, supervised training, etc.).

In some implementations, the model trainer 50 can train the machine-learned node pairing optimization model 36 by modifying values for parameters of the machine-learned model(s) using various training or learning techniques, such as, for example, backwards propagation. For example, the model trainer 50 can obtain an evaluation signal by evaluating training output(s) 45 produced by the machine-learned node pairing optimization model 36 with the optimization function 54 to obtain an evaluation signal. The evaluation signal can be backpropagated from the output (or another source of the evaluation signal) through the machine-learned node pairing optimization model 36 to update one or more parameters of the machine-learned node pairing optimization model 36 (e.g., based on a gradient of the evaluation signal with respect to the parameter value(s)).

The optimization function 54 can be leveraged to perform various types of optimization determinations, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

Specifically, in some implementations, the model trainer 50 can utilize the optimization function 54 to perform an unsupervised training process for the machine-learned node pairing optimization model 36. As described herein, an “unsupervised” training process utilizes unsupervised training examples that do not include any labels or classes, positive examples, negative examples, etc. To do so, the model trainer 50 can process the unsupervised dataset 53A with the machine-learned node pairing optimization model 36 to obtain training outputs 45. The model trainer 50 can perform the unsupervised training process by evaluating the optimization function 54. The optimization function 54 can evaluate the compute node embedding 46 and the storage node embedding 48. For example, the optimization function 54 may evaluate a consistency between the embeddings 46 and 48. The model trainer 50 can evaluate parameters of the machine-learned node pairing optimization model 36 based on the optimization function 54.

Additionally, or alternatively, in some implementations, the model trainer 50 can utilize the optimization function 54 to perform a weakly supervised training process for the machine-learned node pairing optimization model 36. As described herein, a “weakly supervised” training process utilizes partially labeled training examples. For example, assume that the weakly supervised dataset 53B and the supervised dataset 53C both include the same data points. The supervised dataset 53C can include classes / labels for each data point (e.g., whether a particular value represents a “positive” example, etc.). Conversely, the weakly supervised dataset 53B may only include classes / labels at the tuple level (e.g., labeling a set of data points as a “positive” example rather than labeling each data point separately).

To perform the weakly supervised training process, the model trainer 50 can process the weakly supervised dataset 53B with the machine-learned node pairing optimization model 36 to obtain the training output(s) 45. The model trainer 50 can perform the weakly supervised training process by evaluating the optimization function 54. The optimization function 54 can evaluate the performance output and a label indicative of known performance metrics for a plurality of compute-storage pairings. For example, the label indicative of known performance metrics can describe known performance metrics (e.g., at the tuple level, etc.) for pairings of compute nodes and storage nodes known to exhibit favorable performance. The model trainer 50 can evaluate parameters of the machine-learned node pairing optimization model 36 based on the optimization function 54.

Additionally, or alternatively, in some implementations, the model trainer 50 can utilize the optimization function 54 to perform a supervised training process for the machine-learned node pairing optimization model 36. As described herein, a “supervised” training process utilizes supervised training examples that include labels and/or classes for each data point (or most data points), positive examples, negative examples, etc. To do so, the model trainer 50 can process the supervised dataset 53C with the machine-learned node pairing optimization model 36 to obtain training outputs 45. The model trainer 50 can perform the supervised training process by evaluating the optimization function 54. The optimization function 54 can evaluate the performance output and a ground-truth label indicative of a known data transfer performance for the compute-storage pairing. For example, the optimization function 54 may evaluate a consistency between the embeddings 46 and 48. The model trainer 50 can evaluate parameters of the machine-learned node pairing optimization model 36 based on the optimization function 54.

In some implementations, the model trainer 50 can train components or “portions” of the machine-learned node pairing optimization model 36, such as the embedding portion 44 and the learned function 38, in an end-to-end manner. Alternatively, in some implementations, the embedding portion 44 and/or the learned function 38 can be trained separately. The Gradient descent techniques can be used to iteratively update the parameters over a number of training iterations. In some implementations, performing backwards propagation of errors can include performing truncated backpropagation through time. Examples can include implementing a number of generalization techniques (e.g., weight decays, dropouts, etc.) to improve the generalization capability of the models being trained.

In some implementations, the model trainer 50 can train the machine-learned node pairing optimization model 36 from an initialized state to a fully trained state (e.g., when the model exhibits a desired performance profile, such as based on accuracy, precision, recall, etc.). Alternatively, in some implementations, the model trainer 50 can be utilized for particular stages of a training procedure. For instance, in some implementations, the model trainer 50 can be utilized for pre-training a machine-learned model. Pre-training can include, for instance, large-scale training over potentially noisy data to achieve a broad base of performance levels across a variety of tasks/data types.

In some implementations, the model trainer 50 can be implemented for fine-tuning the machine-learned node pairing optimization model 36. Fine-tuning can include, for instance, smaller-scale training on higher-quality (e.g., labeled, curated, etc.) data. Fine-tuning can affect all or a portion of the parameters of a machine-learned model. For example, various portions of the machine-learned node pairing optimization model 36 can be “frozen” for certain training stages. For example, parameters associated with the embedding space 40 can be “frozen” during fine-tuning (e.g., to retain information learned from a broader domain(s) than present in the fine-tuning dataset(s)).

FIG. 1B is a block diagram of a distributed computing environment 10 suitable for leveraging a trained machine-learned node pairing optimization model for inference to identify optimal compute-storage pairings according to some implementations of the present disclosure. Specifically, the distributed computing environment 10 can include the computing system 12 as described with regards to FIG. 1A. The distributed computing environment 10 can further include a storage node 56, a first compute node 58, and a second compute node 60. The nodes 56, 58, and 60 can be located at a first physical geographic location 62A, a second physical geographic location 62B, and a third physical geographic location 62C, respectively (generally, physical geographic locations 62).

Each of the physical geographic locations 62 can be different from each other. For example, the first physical geographic location 62A of the storage node 56 may be the Southwest United States, while the second physical geographic location 62B of the first compute node 58 may be the Midwest United States and the third physical geographic location 62C of the second compute node 60 may be somewhere in South America.

The distributed compute handler 28 of the computing system 12 can obtain the historical performance metrics 32 using the historical performance metric obtainer 30. For example, the historical performance metric obtainer 30 can obtain the historical performance metrics 32 by requesting the metrics from the nodes 56, 58, and 60, or from a data repository 65 that monitors performance of the nodes 56, 58, and 60.

The machine-learned node pairing optimization model 36 can be trained as described with regards to FIG. 1A, and thus can be used for inference. The distributed compute handler 28 can process the historical performance metrics 32 for the nodes 56, 58, and 60 with the machine-learned node pairing optimization model 36. For example, the embedding portion(s) 44 of the machine-learned node pairing optimization model 36 can process the historical performance metrics 32 obtained for the first compute node 58 to obtain a first computing node embedding 63. The embedding portion(s) 44 of the machine-learned node pairing optimization model 36 can process the historical performance metrics 32 obtained for the second compute node 58 to obtain a second computing node embedding 64. The embedding portion(s) 44 of the machine-learned node pairing optimization model 36 can process the historical performance metrics 32 obtained for the storage compute node 56 to obtain a storage node embedding 66. The embeddings 63, 64, and 66 can be mapped to the embedding space 40, along with embeddings for other computing nodes and/or storage nodes.

The distributed compute handler 28 can include a compute-storage pair identifier 68. The compute-storage pair identifier 68 can identify optimal compute-storage pairings. Specifically, the compute-storage pair identifier 68 can create compute-storage pairings by assigning a compute node to a storage node (or vice-versa) based on the historical performance metrics 32.

The compute-storage pair identifier 68 can leverage the machine-learned node pairing optimization model 36 to generate a first compute-storage pair inference output 70 and a second compute-storage pair inference output 72. The compute-storage pair inference outputs 70 and 72 can describe a predicted degree of performance between a first compute-storage pairing including the storage node 56 and the first compute node 58, and a second compute-storage pairing including the storage node 56 and the second compute node 60, respectively.

To obtain the first compute-storage pair inference output 70, the compute-storage pair identifier 68 can evaluate the first compute-storage pair that includes the first compute node 58 and the storage node 56. Specifically, the compute-storage pair identifier can determine a pairwise distance between the nodes by measuring or otherwise determining the pairwise distance between the paired nodes with the learned function 38. For example, assume that the learned function 38 is a learned Mahalanobis distance function. The compute-storage pair identifier 68 can utilize the learned function 38 can generate the first compute-storage pair inference output 70 by evaluating the distance between the first computing node embedding 63 and the storage node embedding 66 within the embedding space 40. The compute-storage pair identifier 68 can utilize the learned function 38 can generate the second compute-storage pair inference output 72 by evaluating the distance between the second computing node embedding 64 and the storage node embedding 66 within the embedding space 40.

Based on the first compute-storage pair inference output 70 and the second compute-storage pair inference output 72, the compute-storage pair identifier 68 can assign the storage node 56 to one of the compute node 58 or the compute node 60. For example, if the distance described by the second compute-storage pair inference output 72 is less than the distance described by the first compute-storage pair inference output 70, the compute-storage pair identifier 68 can determine a compute-storage pairing by assigning the storage node 56 to the second compute node 60.

As described previously, the distances between geographic locations are insufficient in some instances to determine optimal compute-storage pairings. To follow the previous example, assume that a physical distance between the first physical geographic location 62A (e.g., the location of the storage node 56) and the second physical geographic location 62B (e.g., the location of the first compute node 58) is less than the distance between the first geographic location and the third physical geographic location 62C (e.g., the location of the second compute node 60). In other words, assume that the first compute node 58 is physically closer to the storage node 56 than the second compute node 60. In this instance, the compute-storage pair identifier 68 can identify a compute-storage pairing that includes a compute node further away from the paired storage node than other candidate nodes. In such fashion, implementations described herein can determine more optimal compute-storage pairings.

In some implementations, the compute-storage pair identifier 68 can include a node configurator 74. The node configurator 74 can configure the second compute node 60 and/or the storage node 56 to assign the storage node 56 to the second compute node 60 (or vice-versa), or can otherwise cause assignment of the nodes. For example, the compute-storage pair identifier 68 can generate configuration information 76, which can apply a modification to a configuration of the second compute node 60 that causes the second compute node 60 to prioritize the storage node 56 for data transfer requests.

Additionally, or alternatively, in some implementations, the compute-storage pair identifier 68 can generate assignment information 78. The assignment information 78 can describe the assignment between the storage node 56 and the second compute node 60. In some implementations, the assignment information 78 can be provided to the data repository 65 for storage. Additionally, or alternatively, in some implementations, the compute-storage pair identifier 68 can provide the assignment information 78 to the storage node 56 and the compute node 60.

In some implementations, the computing system 12 can include a grouping module 80. The grouping module 80 can group pairwise distances calculated using the learned function 38. More specifically, given large quantities of storage nodes and compute nodes, selecting compute-storage pairings based only on the lowest evaluated distances can, in some instances, cause sub-optimal pairings to occur. More specifically, the compute-storage pairings can be identified by the compute-storage pair identifier 68 in a manner that optimizes overall performance of the distributed compute environment 10, rather than the performance of specific compute-storage pairings.

For example, the evaluated distance (not physical distance) between the storage node 56 and the first compute node 58 may be higher than the evaluated distance between the storage node 56 and the second compute node 60. However, the second compute node 60 may only be capable of connecting to the storage node 56 (e.g., due to failure of other storage nodes local to the second compute node 60. In this instance, the pairing that is optimal for overall performance of the distributed compute environment 10 can be the pairing of the second compute node 60 and the storage node 56, even if the evaluated distance is higher, as a pairing between the storage node 56 and the first compute node 58 would render the compute node 60 inoperable due to a lack of available storage nodes.

As such, the grouping module 80 can select compute-storage pairings using a non-greedy algorithm, such as a bin packing algorithm, dynamic programing algorithm, etc. For example, assume that a large number of storage nodes and compute nodes are included in the distributed compute environment 10. Further assume that the compute-storage pair identifier 68 determines pairwise distances between each possible pairing between the storage nodes and the compute nodes. The grouping module 80 can sort the plurality of pairwise distances into a plurality of distance groups by applying some sorting or grouping algorithm to group pairwise distances between candidate compute-storage pairs. For example, the grouping module 80 may apply a bin-packing algorithm (e.g., refined-harmonic algorithm, refined-first-fit-bin (RFF) packing, etc.) or the like, or an approximation algorithm (e.g., next fit, next k-fit, first-fit, etc.). For another example, the grouping module 80 may apply a greedy algorithm, dynamic programming algorithm, etc. The grouping module 80 can select the “bin” that enables the highest degree of performance from the distributed compute environment 10.

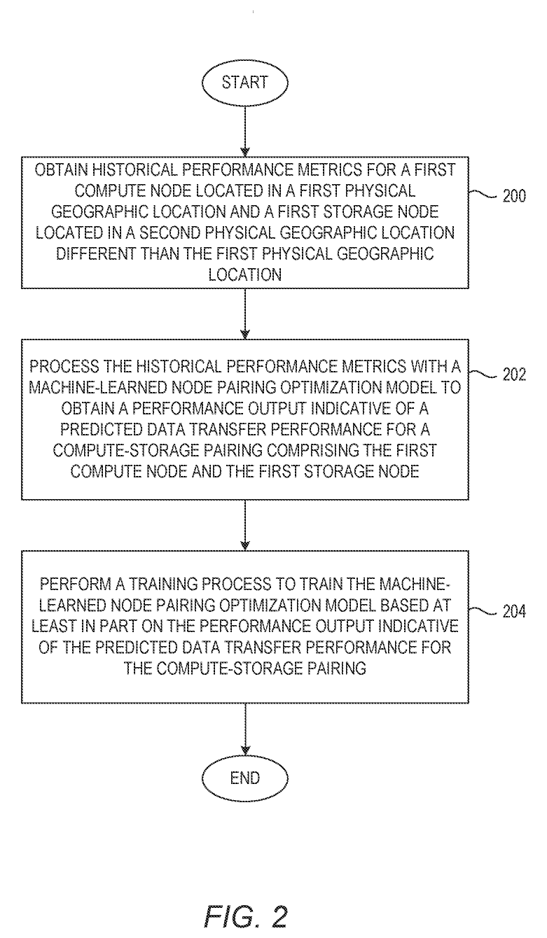

FIG. 2 is a flowchart of a method for coverage based risk mitigation for containers according to some implementations of the present disclosure. FIG. 2 will be discussed in conjunction with FIGS. 1A and 1B.

Historical performance metrics 32 for a compute node 17 are obtained by a computing system 12 located in a first physical geographic location and a storage node 22 located in a second physical geographic location different than the first physical geographic location (block 200). The historical performance metrics 32 are processed by the computing system 12 with a machine-learned node pairing optimization model 36 to obtain a training output 45 indicative of a predicted data transfer performance for a compute-storage pairing including the compute node 17 and the storage node 22 (block 202). A training process is performed by the computing system 12 to train the machine-learned node pairing optimization model 36 based at least in part on the training output 45 indicative of the predicted data transfer performance for the compute-storage pairing (block 204).

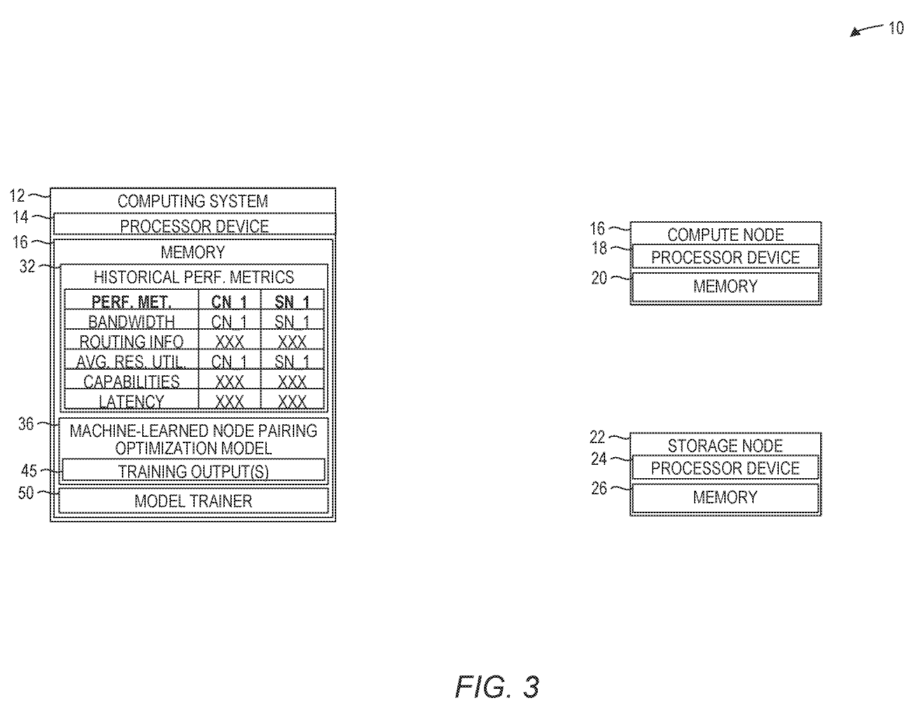

FIG. 3 is a simplified block diagram of the environment illustrated in FIG. 1A according to one implementation of the present disclosure. The computing system 12 includes the memory 16 and the processor device(s) 14 coupled to the memory 16. The processor device(s) 14 are to obtain historical performance metrics 32 for a compute node 17 located in a first physical geographic location and a storage node 22 located in a second physical geographic location different than the first physical geographic location. The processor device(s) 14 are further to process the historical performance metrics 32 with a machine-learned node pairing optimization model 36 to obtain a training output 45 output indicative of a predicted data transfer performance for a compute-storage pairing comprising the compute node 17 and the storage node 22. The processor device(s) 14 are further to perform a training process (e.g., with the model trainer 50) to train the machine-learned node pairing optimization model 36 based at least in part on the training output 45 indicative of the predicted data transfer performance for the compute-storage pairing.

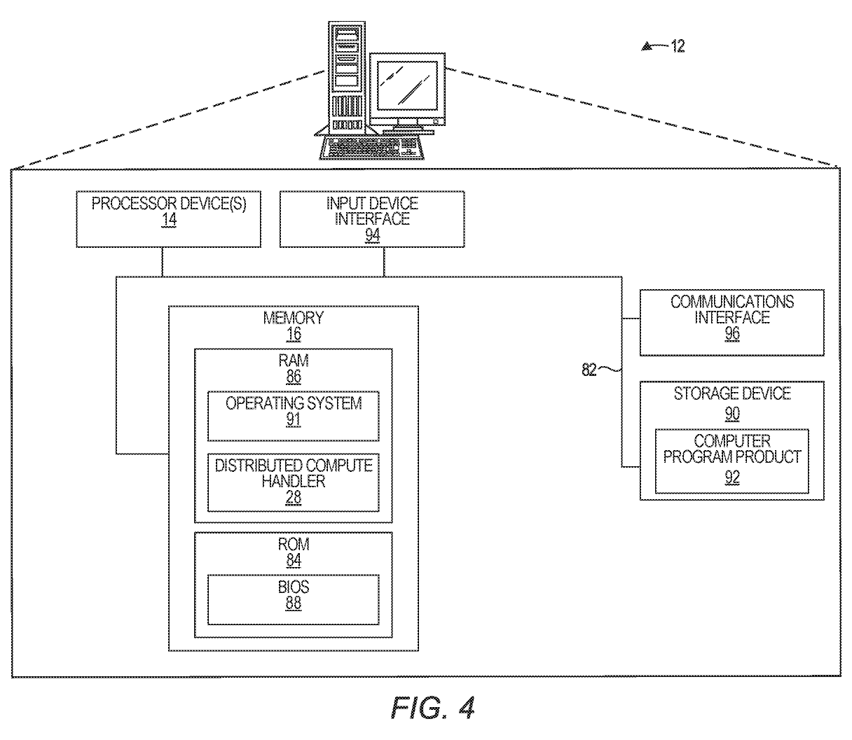

FIG. 4 is a block diagram of the computing system 12 suitable for implementing examples according to one example. The computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 12 includes the processor device 14, the memory 16, and a system bus 82. The system bus 82 provides an interface for system components including, but not limited to, the memory 16 and the processor device(s) 14. The processor device(s) 14 can be or include any commercially available or proprietary processor.

The system bus 82 may be any of several types of bus structures that may further interconnect to a memory bus (with or without a memory controller), a peripheral bus, and/or a local bus using any of a variety of commercially available bus architectures. The memory 16 may include non-volatile memory 84 (e.g., read-only memory (ROM), erasable programmable read-only memory (EPROM), electrically erasable programmable read-only memory (EEPROM), etc.), and volatile memory 86 (e.g., random-access memory (RAM)). A basic input/output system (BIOS) 88 may be stored in the non-volatile memory 84 and can include the basic routines that help to transfer information between elements within the computing system 12. The volatile memory 86 may also include a high-speed RAM, such as static RAM, for caching data.

The computing system 12 may further include or be coupled to a non-transitory computer-readable storage medium such as the storage device 90, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 90 and other drives associated with computer-readable media and computer-usable media may provide non-volatile storage of data, data structures, computer-executable instructions, and the like.

A number of modules can be stored in the storage device 90 and in the volatile memory 86, including an operating system 91 and one or more program modules, such as the distributed compute handler 28, which may implement the functionality described herein in whole or in part. All or a portion of the examples may be implemented as a computer program product 92 stored on a transitory or non-transitory computer-usable or computer-readable storage medium, such as the storage device 90, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the distributed compute handler 28 in the volatile memory 86, may serve as a controller, or control system, for the computing system 12 that is to implement the functionality described herein.

Because the distributed compute handler 28 is a component of the computing system 12, functionality implemented by the distributed compute handler 28 may be attributed to the computing system 12 generally. Moreover, in examples where the distributed compute handler 28 comprises software instructions that program the processor device(s) 14 to carry out functionality discussed herein, functionality implemented by the distributed compute handler 28 may be attributed herein to the processor device(s) 14.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 94 that is coupled to the system bus but can be connected by other interfaces such as a parallel port, an Institute of Electrical and Electronic Engineers (IEEE) 1394 serial port, a Universal Serial Bus (USB) port, an IR interface, and the like. The computing system 12 may also include the communications interface 96 suitable for communicating with the network as appropriate or desired. The computing system 12 may also include a video port configured to interface with the display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
obtaining, by a computing system comprising one or more computing devices, historical performance metrics for a first compute node located in a first physical geographic location and a first storage node located in a second physical geographic location different than the first physical geographic location;
processing, by the computing system, the historical performance metrics with a machine-learned node pairing optimization model to obtain a training output indicative of a predicted data transfer performance for a compute-storage pairing comprising the first compute node and the first storage node; and
performing, by the computing system, a training process to train the machine-learned node pairing optimization model based at least in part on the training output indicative of the predicted data transfer performance for the compute-storage pairing.

2. The method of claim 1, wherein processing the historical performance metrics with the machine-learned node pairing optimization model to obtain the training output comprises:
processing, by the computing system, the historical performance metrics with an embedding portion of the machine-learned node pairing optimization model to obtain a first embedding for the first compute node and a second embedding for the first storage node; and
generating, by the computing system, the training output based on a distance between the first embedding and the second embedding within a learned embedding space.

3. The method of claim 2, wherein the training output comprises the distance between the first embedding and the second embedding.

4. The method of claim 2, wherein performing the training process to train the machine-learned node pairing optimization model based at least in part on the training output indicative of the predicted data transfer performance for the compute-storage pairing comprises:
evaluating, by the computing system, an optimization function that evaluates the first embedding for the first compute node and the second embedding for the first storage node; and
adjusting, by the computing system, one or more parameters of the machine-learned node pairing optimization model based at least in part on the optimization function.

5. The method of claim 1, wherein performing the training process to train the machine-learned node pairing optimization model based at least in part on the training output indicative of the predicted data transfer performance for the compute-storage pairing comprises:
evaluating, by the computing system, an optimization function that evaluates a difference between the training output and a ground-truth label indicative of a known data transfer performance for the compute-storage pairing; and
adjusting, by the computing system, one or more parameters of the machine-learned node pairing optimization model based at least in part on the optimization function.

6. The method of claim 1, wherein performing the training process to train the machine-learned node pairing optimization model based at least in part on the training output indicative of the predicted data transfer performance for the compute-storage pairing comprises:
evaluating, by the computing system, an optimization function that evaluates a difference between the training output and a label indicative of known performance metrics for a plurality of compute-storage pairings; and
adjusting, by the computing system, one or more parameters of the machine-learned node pairing optimization model based at least in part on the optimization function.

7. The method of claim 1, further comprising:
obtaining, by the computing system, second historical performance metrics for a plurality of second nodes comprising a plurality of second compute nodes and a plurality of second storage nodes, wherein the plurality of second nodes are located in a respective plurality of physical geographic locations;
processing, by the computing system, the second historical performance metrics with the machine-learned node pairing optimization model to obtain a plurality of node embeddings comprising a plurality of compute node embeddings for the plurality of second compute nodes and a plurality of storage node embeddings for the plurality of second storage nodes, each of the plurality of node embeddings being located at a corresponding point of a plurality of points within an embedding space; and
based on the plurality of points, determining, by the computing system, a plurality of pairwise distances between each of the plurality of compute node embeddings and each of the plurality of storage node embeddings.

8. The method of claim 7, wherein the method further comprises:
sorting, by the computing system, the plurality of pairwise distances into a plurality of distance groups, wherein each pairwise distance of a first distance group of the plurality of distance groups is less than each pairwise distance of a second distance group of the plurality of distance groups.

9. The method of claim 8, wherein the method further comprises:
selecting, by the computing system, one or more pairwise distances from the first distance group of the plurality of distance groups; and
identifying, by the computing system, one or more compute-storage pairings corresponding to the one or more pairwise distances, each of the one or more compute-storage pairings comprising a second compute node of the plurality of second compute nodes and a second storage node of the plurality of second storage nodes.

10. The method of claim 9, wherein the method further comprises:
for each compute-storage pairing of the one or more compute-storage pairings:
causing, by the computing system, assignment of the second compute node of the compute-storage pairing to the second storage node of the compute-storage pairing.

11. The method of claim 10, wherein causing the assignment of the second compute node of the compute-storage pairing to the second storage node of the compute-storage pairing comprises:
applying, by the computing system, a modification to a configuration of the second compute node of the compute-storage pairing, wherein the modification causes the second compute node to prioritize the second storage node of the compute-storage pairing for data transfer requests.

12. The method of claim 1, wherein the machine-learned node pairing optimization model comprises a Mahalanobis distance function.

13. The method of claim 1, wherein the historical performance metrics for the first compute node is descriptive of at least one of:
historical processor utilization;
historical memory utilization;
prior network performance;
storage capacity;
processing capacity;
geographic location; or
prior latency measurements.

14. The method of claim 1, wherein the historical performance metrics further comprise cost information descriptive of costs associated with utilization of the first compute node and/or the first storage node.

15. A computing system, comprising:
one or more processor devices to:
obtain historical performance metrics for a compute node located in a first physical geographic location;
process the historical performance metrics with a machine-learned node pairing optimization model to obtain an embedding for the compute node; and
determine, within an embedding space, a plurality of pairwise distances between the embedding for the compute node and a plurality of embeddings for a respective plurality of storage nodes located at a plurality of second physical geographic locations each different than the first physical geographic location; and
based on the plurality of pairwise distances, assign the compute node to a first storage node of the plurality of storage nodes, wherein a physical distance between the compute node and the first storage node is greater than a physical distance between the compute node and a second storage node of the plurality of storage nodes.

16. The computing system of claim 15, wherein, to assign the compute node to the first storage node of the plurality of storage nodes, the one or more processor devices are further to:
apply a modification to a configuration of the compute node, wherein the modification causes the compute node to prioritize the first storage node for data transfer requests.

17. The computing system of claim 15, wherein, prior to obtaining the historical performance metrics for the compute node, the one or more processor devices are to:
obtain historical performance training data for a set of compute nodes and a set of storage nodes;
process the historical performance training data with the machine-learned node pairing optimization model to obtain a plurality of model outputs indicative of predicted data transfer performance for a plurality of first compute-storage pairings, each compute-node pairing comprising a compute node of the set of compute nodes and a storage node of the set of storage nodes; and
perform a training process to train the machine-learned node pairing optimization model based at least in part on the plurality of model outputs.

18. The computing system of claim 17, wherein, to perform the training process to train the machine-learned node pairing optimization model based at least in part on the plurality of model outputs, the one or more processor devices are to:
evaluate an optimization function that evaluates differences between the plurality of model outputs and a respective plurality of labels indicative of known performance metrics for a plurality of second compute-storage pairings; and
adjust one or more parameters of the machine-learned node pairing optimization model based at least in part on the optimization function.

19. A non-transitory computer-readable storage medium that includes executable instructions to cause one or more processor devices of a computing system to:
obtain historical performance metrics for a first compute node located in a first physical geographic location and a first storage node located in a second physical geographic location different than the first physical geographic location;
process the historical performance metrics with a machine-learned node pairing optimization model to obtain a model output indicative of a predicted data transfer performance for a compute-storage pairing comprising the first compute node and the first storage node; and
perform a training process to train the machine-learned node pairing optimization model based at least in part on the model output indicative of the predicted data transfer performance for the compute-storage pairing.

20. The non-transitory computer-readable storage medium of claim 19, wherein processing the historical performance metrics with the machine-learned node pairing optimization model to obtain the model output comprises:
processing the historical performance metrics with an embedding portion of the machine-learned node pairing optimization model to obtain a first embedding for the first compute node and a second embedding for the first storage node; and
generating the model output based on a distance between the first embedding and the second embedding within a learned embedding space.
